(19) United States
(12) Patent Application Publication
(10) Pub. No.: US 2004/0025032 A1
(43) Pub. Date: Feb. 5, 2004

(54) Method and system for resistance to statiscal power analysis

(76) Inventors: Stanley T Chow, Nepean (CA); Harold J Johnson, Nepean (CA); James Zhengchu Xiao, Kanata (CA); Miheng Yan, Kanata (CA)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/181,942

(22) PCT Filed: Feb. 19, 2001
(86) PCT No.: PCT/CA01/00200

(30) Foreign Application Priority Data
Feb. 18, 2000 (CA) 2,298,990

(51) Int. Cl. G06F 12/14

(52) U.S. Cl. 713/189

(57) ABSTRACT

New techniques for cracking sealed platforms have recently been discovered which observe power modulation during execution of a software encryption program on a computer processor. Particularly vulnerable to such simple power analysis and differential power analysis attacks are smart cards which employ Data Encryption Standard (DES) protection. The invention protects against such attacks by substantively altering the observable operation of the cryptographic algorithm while it is processing input data. The alterations are generated in a random way and may include average neutral execution, permuted execution or code padding of the cryptographic algorithm.

The present invention relates generally to computer software and electronic hardware, and more specifically, to a method, apparatus and system resistant to power analysis of sealed platforms, including a particular implementation for smart cards employing Data Encryption Standard (DES) protection.

### BACKGROUND OF THE INVENTION

Keeping electronic information hidden from hostile parties is desirable in many environments, whether personal, business, government, or military. Recently, “sealed platforms”, which are special kinds of electronic hardware devices, have been developed to satisfy this need. The term “platform” generally refers to a hardware/software environment capable of supporting computation including the execution of software programs. A “sealed” platform refers to a platform purposely built to frustrate reverse-engineering.

In contrast to traditional credit and debit cards which store a small amount of information on a magnetic strip, the new sealed platforms such as smart cards, may store and process a significantly larger quantity of data using microprocessors, random access memory (RAM), and read only memory (ROM). The new sealed platforms are typically secured using cryptographic technology which is intended to maintain and manipulate secret parameters in open environments without revealing their values. Compromise of a secret key used to compute a digital signature could, for example, allow an attacker to forge the owner's digital signature and execute fraudulent transactions.

A sealed platform is intended to perform its function while protecting information and algorithms, such as performing digital signatures as part of a challenge-response protocol, authenticating commands or requests, and encrypting or decrypting arbitrary data. A smart card used in a stored value system may, for example, digitally sign or compute parameters such as the smart card's serial number, balarice, expiration date, transaction counter, currency, and transaction amount as part of a value transfer.

FIG. 1 presents an exemplary physical structure of a smart card 10, which typically embeds an electronic chip, 12 or chips in a plastic card 14. The electronic chip 12 may include, for example, a microprocessor or similar device, read-only memory (ROM), and/or read-write random access memory (RAM). The electronic chip 12 may also include other electronic components such as digital signal processors (DSPs), field-programmable gate arrays (FPGAs), electrically-erasable programmable read-only memory (EEPROM) and miscellaneous support logic.

Generally, the electronic chip 12 is glued into a recessed area 16 of the plastic card 14 and is covered by a printed circuit 18 which provides the electrical interface to an external smart card reader. The standard configuration of the input and output pads of the printed circuit 18 is shown in detail in FIG. 1, and generally includes power (VCC), ground (GND), a clock input (CLK) and a serial input/output pad (I/O). Several additional unconnected pads (N/C) are also included in the standard configuration. Because the plastic card 14 is somewhat flexible, the electronic chip 12 must be small enough to avoid breaking. This limits the physical size of the electronic chip 12 to a few millimetres across, and also limits the number of electronic components that can be supported.

Contactless smart cards are also in use, which communicate with the external smart card reader using radio frequencies or other wireless communication media. Such smart cards are generally equipped with an internal antenna, rather than the input and output pads of the printed circuit 18.

Data Encryption Standard

Smart cards commonly encode their internal data using a cryptographic technique such as the Data Encryption Standard (DES). DES is a block cipher method using a 64 bit key (of which only 56 bits are actually used), which is very fast and has been widely adopted. Though DES can be cracked by a brute-force attack (simply testing all possible keys), triple DES is still considered very secure (triple DES is simply three copies of DES executed in series).

For the purposes of the examples described hereinafter, it is sufficient to know that the DES algorithm performs 16 rounds which effect lookups to eight separate translation tables called S-boxes. A detailed description of the DES is beyond the scope of this discussion, but is presented by Bruce Schneier in Applied Cryptography, 2^{nd} edition, ISBN 0-471-11709-9, 1996, John Wiley & Sons, at pp. 265-294. For the Federal Information Processing Standard (FIPS) description of DES, see FIPS publication 46-3, available on the Internet at http://csrc.nist.gov/fips/.

Other similar cryptographic techniques are also known in the art, including: triple DES, IDEA, SEAL, and RC4; public key (asymmetric) encryption and decryption using RSA and EIGamal; digital signatures using DSA, EIGamal, and RSA; and Diffie-Hellman key agreement protocols. Despite the theoretical strength and complexity of these cryptographic systems, Power Analysis techniques have recently been developed which allow these keys to be cracked much more quickly.

Power Analysis (PA)

Power analysis is the process of gathering information about the data and algorithms embodied on a platform by means of the “power signature” of the platform. The “power signature” of a platform is its power consumption profile measured over time, while executing the software stored on that platform.

The power consumed by a microprocessor, micro-controller or similar electronic device changes with the state of the electronic components in the device. Such devices generally represent data in terms of binary 1s and 0s, which are represented in the electronic devices as corresponding high or low voltage levels.

For example, a value of 1 may be represented by +5 volts and a value of 0 by 0 volts.

Hence, the amount of power that a sealed platform consumes may be correlated with the number of binary 1s in a data word, at a given moment in time. It follows that the amount of current drawn by, and the electromagnetic radiation emanated from a sealed platform, may be correlated to the secrets being manipulated within it. Such signals can be measured and analysed by attackers to recover secret keys.

State transitions are also a major influence on the power consumption of a device performing a computation. As the value of a bit changes, transistor switches associated with that bit change state. Therefore, there is an increase in the amount of power consumed when-the system is in transition.

Paul Kocher, Joshua Jaffe and Benjamin Jun, in their Introduction to differential power analysis and related attacks, 1998 (available on the Internet at http://www.cryptography.com/dpa/technical), show that attackers can often non-invasively extract secret keys using external measurement and analysis of a device's power consumption, electromagnetic radiation, or processor cycle timing during performance of cryptographic operations. Other similar extraction techniques would be clear to one skilled in the art from the teachings of Kocher et al.

Smart cards, for example, require an external power supply to operate. The current and voltage being supplied to the smart card may easily be monitored while it is executing, using an arrangement such as that presented in FIG. 2. In this arrangement, the smart card 10 is provided with an external power supply 20, and its operation is monitored using a standard personal computer 22 running appropriate analysis software. The power consumed by the smart card 10 is monitored using a pickup 24, whose data is digitized for the personal computer (PC) 22 using an analogue to digital convertor 26. The PC 22 also provides a clock signal (CLK) to the smart card 10 and communicates data via its serial input and output port (DIGITAL I/O). This arrangement allows the attacker to monitor the power consumed by the smart card 10 while it is processing known data.

Simple Power Analysis (SPA)

In simple power analysis (SPA), the power signature for the execution of a given algorithm is used to determine information about the algorithm and its data. Generally, power data is gathered from many executions and averaged at each point in time in the profile.

For example, if SPA is used to attack a DES key space, and the attacker has access to the specific code, but not the particular DES key, a particular series of points in the power signature may indicate the number of 1s and 0s in each 8-bit byte of the DES key (note that the term “byte” will generally refer to an 8-bit byte in this document). This reduces the space of possible keys for an exhaustive all-possible-keys attack from 256 possible keys to 238 possible keys (if parity bits are stored for each byte of the key), making search time among possible keys about 218 times shorter.

Differential Power Analysis (DPA)

Differential power analysis (DPA) is a form of power analysis in which information is extracted by means of gathering multiple power signatures and analysing the differences between them (see Paul Kocher, Joshua Jaffe and Benjamin Jun, 1998, Introduction to differential power analysis and related attacks; available at http://www.cryptography.com/dpa/technical). For certain kinds of data and algorithms, exhibiting repetitious behaviour, it is an extraordinarily effective method for penetrating secrets stored on sealed platforms. It can reveal information about the data resulting from computations, fetches from memory, stores to memory, the data addresses in the memory of the sealed platform from which data are fetched or to which data are stored during execution, and the code addresses from which instructions are fetched during the execution of algorithms on the sealed platform. These capabilities render protection of sealed platforms against DPA attack both very important to security and very difficult to achieve on inexpensive sealed platforms.

While SPA attacks use primarily visual inspection to identify relevant power fluctuations, DPA attacks use statistical analysis and error correction techniques to extract information correlated to secret keys. Hence, DPA is a much more powerful attack than SPA, and is much more difficult to prevent.

One use for DPA is to extract cryptographic keys for encryptions or decryptions performed on a sealed platform. For the Data Encryption Standard (DES), DPA has proved extremely effective; low-cost smart cards performing DES have proven, in recent experience, to be highly vulnerable to DPA. Any form of encryption or decryption which is similar to DES would necessarily have similar vulnerabilities when incarnated on low-cost smart cards or similar sealed platforms.

DPA Example: Finding a DES Key

Implementation of a DPA attack involves two phases: data collection, followed by data analysis. Data collection for DPA may be performed as described with respect to FIG. 2, by sampling a device's power consumption during cryptographic operations as a function of time or number of clock cycles. For DPA, a number of cryptographic operations using the target key are observed.

To perform such an attack on a smart card, one processes a large number (a thousand or more) DES encryptions (or decryptions) on distinct plaintexts (or ciphertexts), recording:

1. the power profile;

2. the input, chosen at random by the attacker; and

3. the output, computed by the smartcard as the encrypted of decrypted value with the hidden key for each.

Each power profile is referred to as a sample.

In each round of DES, the output of a given S-box is dependent on both the data to be encrypted (or decrypted) and the key. Since the attacker knows the input text, he guesses what the value of the key is, that was used to generate a particular power signature sample, so he can determine whether a particular output bit of a given S-box is 1 or 0 for the particular data used in the sample (note that each standard S-box has a 6-bit input and a 4-bit output). Typically, this analysis begins in round 1 or 16 since those are the ones where the attacker knows either the exact inputs (for round 1) or outputs (for round 16) for the respective S-box.

The attacker does not know the key, but because the DES algorithm only performs one S-box lookup at a time, it is only necessary to guess the six bits of the secret key that are relevant to the S-box being observed (and corresponding to the power consumption) at that time. As only 6-bits are relevant, it is only necessary to test 2⁶=64 possible sequences of values for a given 6-bit portion of the 56-bit secret key. For each guess of the values of these six bits, one divides the samples into two groups: those in which the targeted output bit (that is, one of the four output bits from a targeted S-box which is chosen as a target in the first round of the attack) is a 1 if the attacker's guess of the six key bits is correct (the 1-group), and those in which it is a 0 if the attacker's guess of the six key bits is correct (the 0-group).

The power samples in each group are then averaged. On average, modulo minor asymmetries in DES, those portions of the averaged power profiles which are affected only by bits other than the particular output bit mentioned above, should be similar, since on average, in both groups, they should be 1 for about half of the samples in each group, and 0 for about half of the samples in each group.

However, those portions of the averaged power profiles which are affected by the above-mentioned output bit should show a distinct difference between the 1-group and the 0-group. The presence of such a difference, or multiple such differences, indicates that the guessed value of the six key bits was correct. Its absence, or the absence of such differences, shows that the guessed value of the six key bits was incorrect.

This process of guessing at the value of the secret key, dividing the power signature samples into those which will yield a 1-output and those which will yield a 0-output (the 1-group and 0-group respectively), averaging the profiles, and seeking the above-mentioned distinct difference, is repeated until a guess is shown to be correct. One then has six bits of the key.

The above guessing procedure is repeated for the other seven S-boxes. When all S-boxes have been treated in this way, one has obtained 48 out of the 56 key bits, leaving only eight bits undetermined. This means one need only search a remaining key space of 2⁸=256 possible keys to find the balance of the correct secret key.

Note how little information the attacker needs to employ such an attack. The attacker does not have to know:

1. the specific code used to implement DES;

2. the memory layout used for storing the S-boxes;

3. where in the power profile the distinct difference or difference, if any, is expected to appear for a correct guess;

4. how many such distinct differences are expected to appear in the power profile for a correct guess; or

5. whether the chosen S-box output bits are normal or complemented as flipping 1s and 0s will produce the same kind of distinct difference. DPA is only dependent on whether such a difference exists, not in the sign, + or −, of any given difference.

All an attacker really needs to know in order to mount a successful attack is that it is DES which is being attacked, and that the implementation of DES, at some point, employs a bit which corresponds to a specific output of the S-box, in such a way that its use will affect the power profile samples. The paucity of knowledge required to make a successful DPA attack which completely cracks a hidden DES key on a sealed platform clearly shows that DPA is a very effective means of penetrating a sealed platform.

Only one specific form of DPA attack is described herein, but there are many related forms of DPA attacks which are also possible. Other examples of DPA being used to extract a DES key, which demonstrate the extraordinary power of this technique are presented by:

1. Paul Kocher, Joshua Jaffe, and Benjamin Jun, 1998, Introduction to differential power analysis and related attacks, available at http://www.cryptography.com/dpa/technical;

2. Thomas S. Messerges, Ezzy A. Dabbish, and Robert H. Sloan, 1999, Investigations of power analysis attacks on smart cards, Usenix '99; see http://www.eecs.edu/˜tmesserg/ usenix99/html/paper.html; and

3. Louis Goubin and Jacques Patarin, 1999, DES and differential power analysis: the “duplication” method, Proceedings of CHES '99, Springer Lecture Notes in Computer Science, vol. 1717 (August 1999); available at http://www.cryptosoft.com/html/secpub.htm#goubin.

While the effects of a single transistor switching would be normally be impossible to identify from direct observations of a device's power consumption, the statistical operations used in DPA are able to reliably identify extraordinarily small differences in power consumption.

Physical Protection

Physical measures to protect sealed platforms against attack are known to include: enclosing systems in physically durable enclosures, physical shielding of memory cells and data lines, physical isolation, and coating integrated circuits with special coatings that destroy the chip when removed. While such techniques may offer a degree of protection against physical damage and reverse engineering, these techniques do not protect against non-invasive power analysis methods.

Some devices, such as those shielded to United States Government Tempest specifications, use large capacitors and other power regulation systems to minimize variations in power consumption, enclosing devices in well-shielded cases to prevent electromagnetic radiation, and buffering inputs and outputs to hinder external monitoring.

These techniques are often expensive or physically cumbersome, and are therefore inappropriate for many applications, for smart cards, secure microprocessors, and other small, low-cost, devices. Physical protection is generally inapplicable or insufficient due to reliance on external power sources, the physical impracticality of shielding, cost, and other characteristics imposed by a sealed platform's physical constraints such as size and weight.

Software Protection

In contrast to physical protection, smart cards may also be protected from a power analysis attack to an extent, at the software level, by representing data in a “Hamming neutral” form. The Hamming weight of a bit string, such as a data word or byte, is the quantity of bits in the bit string with a value of 1. For example, 10100 will have a Hamming weight of 2, and 1111 will have a Hamming weight of 4.

A set of “Hamming neutral” bit-strings is a set of bit-strings that all have the same number of 1s, for example, the set {011, 101, 110} is a Hamming neutral set. If all of the data bytes manipulated by a software application have the same number of 1s, clearly, the power consumed by the device and the noise it emits will not vary as the device processes this data.

For example, one could encode a bit string by replacing each “1” with a “10”, and each “0” with a “01”. All bit-strings would then have an equal number of 1s and 0s, and there would be no detectable power or noise variation between any pair of bit-strings. This technique is well known in the art of electrical signalling and hardware design, where it is referred to as power balanced or differential signalling. The benefits of such circuits include:

reduction in noise emissions or induction of cross-talk in other circuits;

reduction in ground bounce; because power requirements are constant, the voltage of the ground bus does not rise locally when a circuit switches from low to high; and

independence from environmental noise; as both electrical lines in a differential pair are influenced by essentially the same level of environmental noise, there is theoretically no net difference detected at the receiving end.

These techniques are commonly used in military, super computer and industrial control applications. Further information on such techniques is widely available, and includes: Kolodzey J S. CRAY-1 computer technology, IEEE Transactions on Components Hybrids & Manufacturing Technology, Vol. CHMT-4, No. 2, June 1981, pp. 181-6, USA, and Russell R M, The CRAY-1 computer system, Communications of the ACM, Vol. 21, No. 1, January 1978, pp. 63-72, USA.

Of course, this approach requires the width of all data buses, memory and computational hardware to be increased to handle the new codings. Using the exemplary mapping above, 0→01 and 1→10, for example, all of these resources would have to double in capacity. More complex mappings are also possible with corresponding increases in overhead, for example, the mapping: 0→0110 and 1→1001, would require a four-fold increase in resource overhead.

The software programming needed to manipulate these Hamming-neutral data bytes can be considerably more complex than regular software programming, requiring the creation of new functions to manipulate such abstract codings mathematically. For example, the boolean calculation (1 OR 0) would map onto (10 OR 01), which could clearly not be effected using the standard OR operator. As well, it is preferable that the new functions perform their calculations in such a manner that the power emitted while calculating would also be Hamming-neutral (referred to herein as Hamming-neutral processing or Hamming-neutral execution), or the benefit of the Hamming-neutral data presentation would be reduced. The overhead of these added hardware capacities and software complexities generally makes the cost of such smart cards too great to be competitive.

Since a normal, unsealed platform is susceptible to attacks potentially more powerful than power analysis (PA), the use of PA in discovery of secret information is primarily directed toward sealed platforms, such as smart cards. However, a simulated power profile of execution can be generated on a simulator for any processor, so it is possible to analyse algorithms for execution on ordinary, unsealed platforms using PA. Hence, although the most urgent need for PA resistance is for use on sealed platforms, such as smart cards, PA resistance is applicable to a much wider variety of platforms.

Improved security is therefore necessary for such devices to be securely used in a broad range of applications in addition to traditional retail commerce, including parking meters, cellular and pay telephones, pay television, banking, Internet-based electronic commerce, storage of medical records, identification and security access.

There is therefore a need for a method, apparatus and system to reduce the amount of useful information leaked to attackers without resulting in excessive overheads. Reducing leakage refers generally to reducing the leakage of any information that is potentially useful to an attacker trying to determine secret information.

### SUMMARY OF THE INVENTION

It is therefore an object of the invention to provide a method and system which obviates or mitigates at least one of the disadvantages of the prior art.

One aspect of the invention is broadly defined as a method of processing a message using a cryptographic algorithm in a manner resistant to external detection of secret information, comprising the steps of: receiving input data; generating a random value; and substantively altering the observable operation of said cryptographic algorithm while processing said input data, in accordance with said random value, frustrating the correlation of output power emissions with any meaningful internal processing.

Another aspect of the invention is defined as an apparatus for processing a message using a cryptographic algorithm in a manner resistant to external detection of secret information, comprising: means for receiving input data; means for generating a random value; and means for substantively altering the observable operation of said cryptographic algorithm while processing said input data, in accordance with said random value, frustrating the correlation of output power emissions with any meaningful internal processing.

An additional aspect of the invention is defined as a computer readable memory medium for storing software code executable to perform the method steps of: receiving input data; generating a random value; and substantively altering the observable operation of said cryptographic algorithm while processing said input data, in accordance with said random value, frustrating the correlation of output power emissions with any meaningful internal processing.

A further aspect of the invention is defined as a carrier signal incorporating software code executable to perform the method steps of: receiving input data; generating a random value; and substantively altering the observable operation of said cryptographic algorithm while processing said input data, in accordance with said random value, frustrating the correlation of output power emissions with any meaningful internal processing.

### BRIEF DESCRIPTION OF THE DRAWINGS

These and other features of the invention will become more apparent from the following description in which reference is made to the appended drawings in which:

FIG. 1 presents an exemplary diagram of a smart card as known in the art;

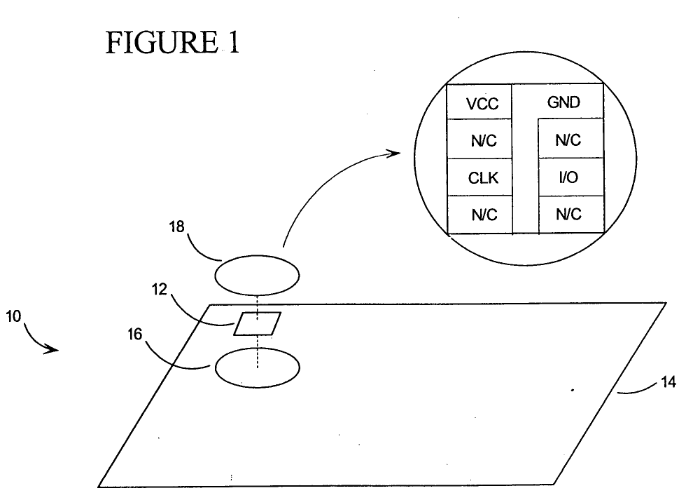

FIG. 2 presents an exemplary physical layout of a system for monitoring and cracking a smart card using power analysis, as known in the art;

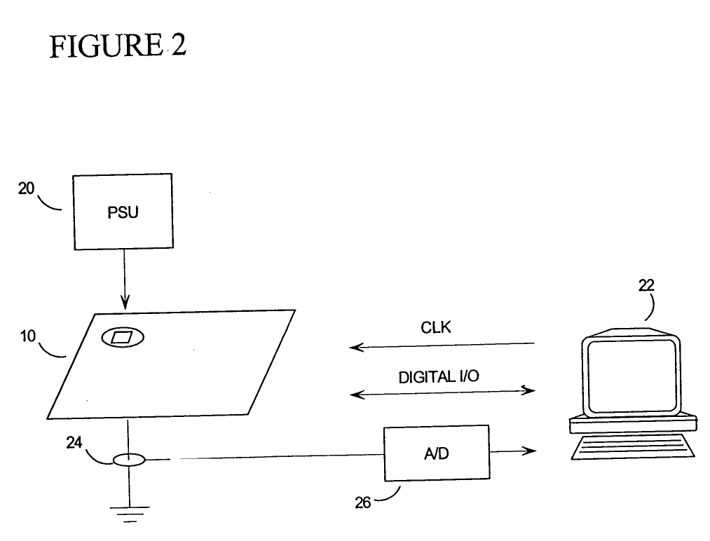

FIG. 3 presents a flow chart of a broad method of the invention;

FIG. 4 presents a flow chart of a general embodiment of the average-neutral technique of the invention;

FIG. 5 presents a flow chart of the average-neutral technique in a preferred embodiment of the invention;

FIG. 6 presents a flow chart of a general embodiment of the permuted execution technique of the invention;

FIG. 7 presents a flow chart of the permuted execution technique in a preferred embodiment of the invention;

FIG. 8 presents a flow chart of a general embodiment of the code-padding execution technique of the invention;

FIG. 9 presents a flow chart of the code-padding execution technique in a preferred embodiment of the invention; and

FIG. 10 presents an exemplary Hamming Neutral look up table in a preferred method of the invention.

### DESCRIPTION OF THE INVENTION

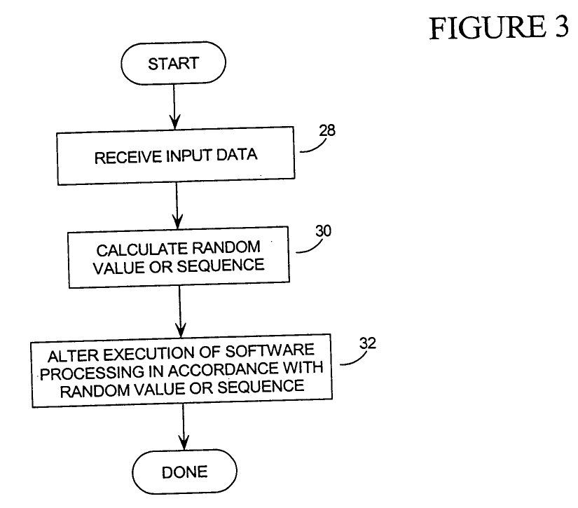

A method which addresses the objects outlined above, is presented as a flow chart in FIG. 3. This figure presents a method of processing a message using a cryptographic algorithm in a manner resistant to external detection of secret information, by receiving input data at step 28, and generating a random or pseudo-random value at step 30. At step 32, this random value is used to substantively alter the observable operation of said cryptographic algorithm while processing the input data, frustrating the correlation of output power emissions with any meaningful internal processing. This process obscures the correlation of output power emissions with the corresponding internal software code.

As described above, the differential power analysis (DPA) method collects power samples of the same code executing a large number of different test data and divides those test data into two groups: those for which the targeted output bit from an S-box will have a value of b=0 and those for which the targeted output bit will have a value of b=1. The samples in those two groups are then averaged together and differences are sought. If the attacker's guess at the key is incorrect, the power signature will reflect an output that is a random collection of 0s and 1s, so the average power signature will not vary between the 0-group and the 1-group. On the other hand, if the guess is correct, there will be a distinct difference between the power signatures of the two groups.

The invention defeats the SPA and DPA attacks, because the attacker can no longer obtain meaningful data. These attacks require that the attacker observe all of the power samples taken at a particular point in the executing software. Generally, this is done by use of the elapsed number of clock cycles. In the standards which apply DES to smart cards, an external clock is used. Therefore, it is easy to monitor the current position in the algorithm during monitoring, and to correlate successive power samples.

The invention provides software-based means for protecting the data and algorithms resident on a sealed platform, such as a smart card, against discovery by means of power analysis (PA). The invention may be used to upgrade existing sealed platforms which are programmable, or conversely, may be implemented in a pure hardware form.

The invention is intended to render secret information used during execution immune to PA-based attacks, even when the algorithms employing the secret information are, in their ordinary implementations, vulnerable to such attacks. The method of the invention can be applied to any algorithm vulnerable to a DPA attack, including for example: triple DES, IDEA, SEAL, and RC4; public key (asymmetric) encryption and decryption using RSA and EIGamal; digital signatures using DSA, EIGamal, and RSA; and Diffie-Hellman key agreement protocols.

Some sealed platforms are limited by the number of executions that they are allowed to perform. Therefore, if the number of transactions required to crack the sealed platform exceeds the number of allowed transactions, an attacker cannot perform enough tests to crack the sealed platform.

The relative magnitude of variations in power consumption will depend, in part, on the family of logic used in the sealed platform, though the invention is not limited to any particular family. For example, with CMOS logic, changes in the system state have a more pronounced effect on power consumption than some other families.

Three exemplary techniques which employ the method of the invention are described hereinafter: average neutral execution, permuted execution, and hash-controlled code padding. Each of these techniques avoids the overhead of using Hamming-neutral execution methods as the sole line of defence against power analysis attacks. Additional advantages are also noted.

In general, these descriptions are given from the perspective of resistance to an attack, but of course this is not the case in normal use as the cryptographic software algorithm cannot distinguish an attacker's input from any other input. That is, the software of the invention will execute in exactly the same fashion in normal use or during a power analysis attack.

Average-Neutral Execution Method

The power analysis (PA) attack used to find a secret DES key has the following characteristics:

1. it requires a reference implementation of the algorithm available for the purpose of predicting expected power analysis events, though not the complete code;

2. it works only for algorithms which have fairly regular relationships between the part of an algorithm being executed and the time-position in a trace at which related power consumption events are expected to occur. Where such events can be predicted on some inputs but not others, the difference between these two cases can be used to identify whether unknown aspects of the algorithm (some bits of the secret key, in the DES example) have been guessed correctly; and

3. since implementations of hardware tend to be somewhat noisy in the power consumption domain, it relies on a significant degree of statistical averaging to obtain a trace of power consumption in which noise has been reduced by averaging many individual traces together and by making the normally predictable events unpredictable.

Many algorithms have properties which make them vulnerable to a PA attack with these characteristics. This embodiment of the invention provides a technique for foiling the above kind of power analysis attack by causing the noise reduction by averaging to fail.

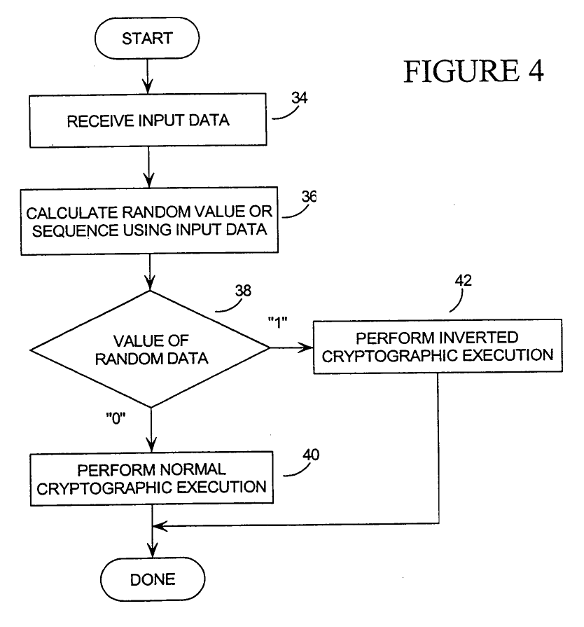

The method of this embodiment is presented as a flow chart in FIG. 4. In response to input data being received at step 34, the algorithm calculates a random value or sequence based on this input data at step 36. The calculation of the random value or sequence may be performed using a method known in the art of random or pseudo-random generating software, such as inversive, linear, multiple recursive or Monte Carlo methods. By using the input data as a seed for the random function, the random sequence will change with each set of data input.

Next, cryptographic processing of the input data is performed, but this processing varies with the values of the random sequence. For example, the value of the random data may be referenced at step 38, and regular execution of a portion of the cryptographic algorithm performed at step 40 if the random value is a “0”, while inverted execution is performed at step 42 if the value is a “1”. This selection process and the manipulations will be described in greater detail hereinafter, but it is important to note that these manipulations make it impossible to correlate the input data with the manipulations being performed by the sealed platform.

Random inversions will typically result in the large power differences associated with a correct guess of the secret key, being eliminated. DPA relies on the correct key consistently providing a distinction between the 0-groups and 1-groups. If the data values are randomly distributed between inverted and non-inverted states, they will statistically balance, and no such distinction will result.

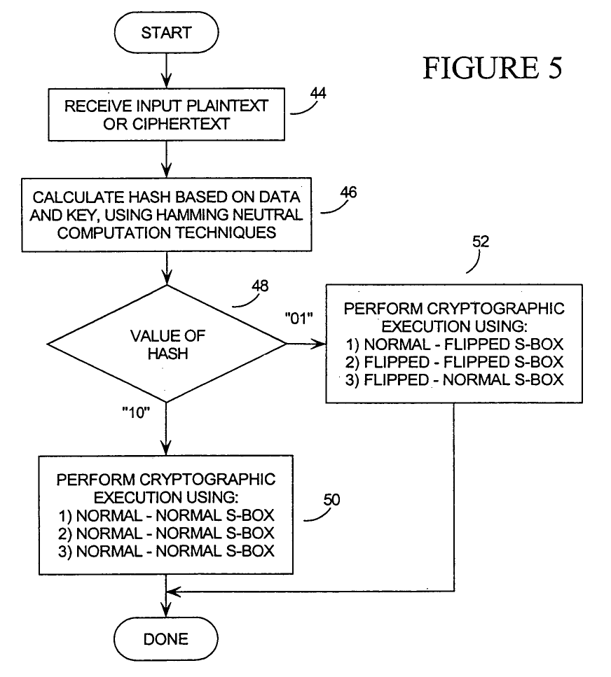

The specific application of this embodiment to a DES algorithm on a smart card is now described With respect to FIG. 5. In the preferred embodiment, it is desirable to perform a certain amount of Hamming-neutral computation in preparation for protecting computations which need not be Hamming-neutral against averaged power analysis attacks, especially differential ones (such as DPA).

Performing such preparatory computations in a Hamming-neutral manner enhances the degree of protection this method provides, as it makes the expected power signature less predictable to an attacker. If non-Hamming-neutral techniques are used some protection would be provided, but it would be reduced.

Firstly, data are input at step 44, which generally consists of a string of ciphertext to be decoded, or plaintext to be encoded. A DPA attack does not care whether ciphertext or plaintext is entered; all that is required is that the attacker correctly distinguish between the two groups of power samples (the 1-group and the 0-group). As noted above, guesses of the keys will be tested in a logical sequence, testing the 2⁶=64 combinations for each 6 bits used in a given round of the DES algorithm.

Next, at step 46, a random sequence is generated, preferably using a pseudo-random hashing function known in the art, seeded with the input data at step 44. In the case of DES, this input data would include the data to be encrypted or decrypted, and preferably would also include the value for the hidden key. The hidden key is convenient because it is already known to the smart card performing the hash, indeed, the actual hash function could have the key already embedded.

The “random value” generated, at step 46 is better described as a “hash of all the input data bits” which should approximate be random. It is desirable that the hash depend on all the input bits since that ensures an attacker cannot sensibly compare two samples. The key property of the hash function is that changing any input bit has an approximately 50% chance of changing (each bit of) the hash.

The calculation of the hash sequence is preferably performed using Hamming-neutral methods, so the value of the Boolean output(s) is/are hidden from an attacker, and the values in the resulting sequence preferably have the same Hamming weight (that is, they are members of a Hamming-neutral set). Note that the use of the hash function will provide a random sequence that is non-reversible, thereby providing added security against information leakage.

At step 48, the values of the hashing sequence are then used to select between a normal computation of the algorithm at step 50 and an implementation in which bits which the attacker might predict in his attack are inverted (1s becoming 0s and vice versa) at step 52. This selection may be performed using Hamming-neutral computation methods, described in greater detail hereinafter.

Consider how one might perform DES according to this scheme. In the simplest form (and in FIG. 5), the hash output is only a single bit. This one bit will control the entire encryption to be “normal” or “flipped”. One would compute, by a Hamming-neutral way, a hash of the input key and the test data at step 46, producing one Boolean result represented by two bits: true=10, and false=01.

As noted above, DES employs eight S-boxes as lookup tables, which are indexed in a loop which is repeated 16 times. This embodiment of the invention replaces each S-box with sets of inverted and non-inverted S-boxes. The power emitted, transitions performed and timing required, can all be balanced, by creating four new sets of S-boxes spanning all combinations of flipped and normal:

1. for inverted execution per step 52, the first round will be “normal-to-flipped”, the middle 14 rounds will be “flipped-to-flipped”; the last round will be “flipped-to-normal”; and

2. for non-inverted execution per step 50, the first round will be “normal-to-normal”, the middle 14 rounds will be “normal-to-normal” and the last round will be “normal-to-normal”. The same “normal-to-normal” set can be used in all three places, though additional security can be provided by generating three identical copies of the “normal-to-normal” S-boxes to make sure all power/address/data are truly matched.

The effect of these S-boxes is to balance transitions in one direction with transitions in another, and to balance high Hamming weights with low Hamming weights when averaging the power signature samples. Also, this method makes the direction of differences in the trace average out due to the unpredictable complementation or absence thereof, of the events to be predicted by the attacker.

In a more complex form, the hash output is say 16 bits, with each bit controlling a single round. The appropriate sense of S-Box per round is then chosen, depending on the sense from the preceding round.

The senses of S-Box are a very simple re-coding of the standard DES S-Boxes. Since DES is being computed, the standard S-Boxes are used and not a new custom set, avoiding the well known “S-Box generation” problem.

The standard DES S-Boxes are usually specified as a table of 64 (2⁶=64) entries, each entry being 4 bits:

0 0 0 0 0 0=>0 1 1 0

0 0 0 0 0 1=>0 1 0 1

0 0 0 0 1 0=>1 1 0 0

0 0 0 0 1 1=>0 1 1 1

To generate a “flipped” output, each output bit in the table is literally inverted, so the output will become (for a normal-to-flipped sense):

0 0 0 0 0 0=>1 0 0 1

0 0 0 0 0 1=>1 0 1 0

0 0 0 0 1 0=>0 0 1 1

0 0 0 0 1 1=>1 0 0 0

To generate a flipped input, each input bit is literally flipped, so the flipped-to-normal sense looks like:

1 1 1 1 1 1=>0 1 1 0

1 1 1 1 1 0=>0 1 0 1

1 1 1 1 0 1=>1 1 0 0

1 1 1 1 0 0=>0 1 1 1

For flipped-to-flipped, both inversions are performed:

1 1 1 1 1 1=>1 0 0 1

1 1 1 1 1 0=>1 0 1 0

1 1 1 1 0 1=>0 0 1 1

1 1 1 1 0 0=>1 0 0 0

In reality, all four senses represent the same S-Box, except that some use 5V=>1, 0V=>0 and others use 5V=>0, 0V=>1 which will balance out the power consumption.

Similar sets of S-boxes are generated for each of the eight S-boxes in the DES algorithm. This replaces one set of eight S-boxes in normal execution by four sets of eight S-boxes for average-neutral execution. However, S-boxes are compact, so this introduces little overhead. Moreover, the only parts of the computation which should be performed in a Hamming-neutral fashion are the hashing to produce the Boolean and the selection between pairs of sets of S-boxes.

Selection of which stream to execute, at step 48, may be made using Hamming-neutral addressing, described hereinafter, which selects the base address for the appropriate set of S-boxes.

Permuted Execution Method

Another form of protection one can apply without incurring the full overhead of using Hamming-neutral execution throughout, is permuted execution. The essence of permuted execution is to randomly alter the order in which software code is executed. DPA relies on the comparison of power signatures with respect to time, or more precisely, with respect to the number of executed clock cycles, over many runs (say 1000). Permuted execution makes the sequence of execution different with-each run, so that the power signatures with respect to time are no longer associated with the same sequence of execution. Because there is no regular and predictable association between power and time, power samples from different runs of the software cannot be compared with one another.

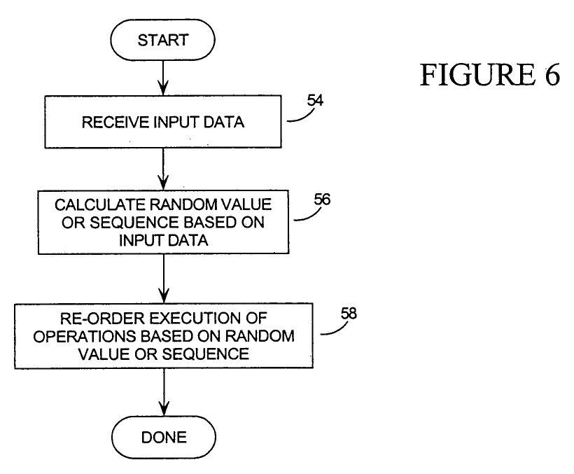

FIG. 6 presents this method in a simple flow chart. At step 54, a set of test data is received, and at step 56, a random value or sequence is generated based on this input data. Because the attacker inputs different data with each run, the result of the random generation will also vary with each run. At step 58, the operations in the processing software are then re-ordered in accordance with the random value or sequence, disrupting the correlation between the power signatures of the different runs. The software processes which may be re-ordered will depend on the code itself, as clearly, the logic of the code cannot be altered.

This technique is particularly useful for the DES algorithm, as within each round, the S-boxes can be accessed in pseudo-random permuted order.

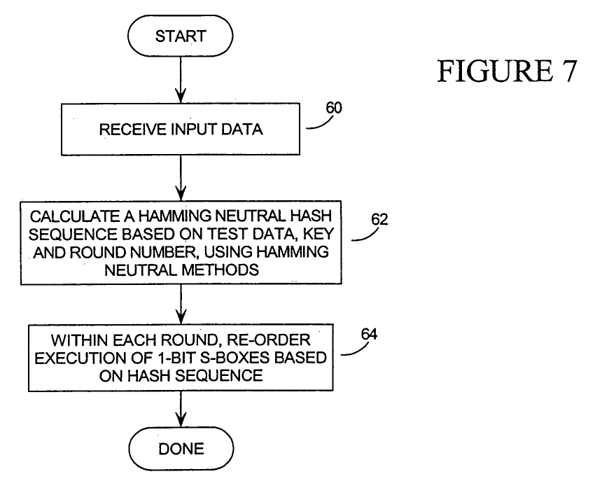

FIG. 7 presents a flow chart of how this technique may be applied to the DES algorithm. Like the average-neutral method, this technique is preferably done with a certain amount of Hamming-neutral computation in preparation for protecting computations, which need not be Hamming-neutral, against averaged power analysis attacks, especially differential ones (DPA). These preparatory computations should be Hamming-neutral, according to the co-pending invention identified hereinafter; if they were not, the amount of protection this method could provide would be compromised, since the expected power signature would be more predictable to the attacker. Some degree of protection would be provided, but it would be reduced.

At step 60, ciphertext or plaintext data is input. The algorithm then calculates a hash sequence at step 62, using as a seed, the ciphertext or plaintext test data, hidden key and possibly a round number. This hash is preferably calculated using Hamming-neutral computation, and generates a sequence containing only Hamming-neutral data elements. Each sequence represents a chosen order of execution for a set of computations which can be performed in any order; hence, pseudo-randomly ordering the computations permissible. The indexing of the elements can be sequential: it need not be Hamming-neutral, since the order of accessing the elements of the permutation does not reveal the order of execution.

In the case of DES, the algorithm may hash all the input bits to produce a single sequence. This sequence is an approximately random permutation of 0, 1, . . . , 6, 7 since it will be used to re-order the accesses to the S-boxes at step 64. The simplest application is to use a single sequence in all 16 rounds, each round performing S-box access in the same order but this order would be different and unpredictable for each input.

In doing so, one should be careful to use Hamming-neutral methods to conceal any information which might reveal the chosen permutation or permutations of operations. Except for the Hamming neutrality required for this purpose, the rest of the computations and representations can be ordinary, unprotected ones.

The effect of this technique is to ‘smear’ the time positions of features in the power signature of the DES computation when averaging of power signatures is performed, causing averaging of power signature events for predicted bits with those for other bits.

In order to increase the effect of the permutations, it is preferred to subdivide the computation into finer grained pieces. For example, in the case of DES, one could replace the eight standard S-boxes by 32 output-bit-separated S-boxes. That is, each original S-box with a four bit output, would be replaced with four, single output-bit-separated S-boxes. The hash sequence used to permute these lookups would desirably be a permutation of the sequence 0, 1, . . . , 30, 31.

This would ‘smear’ the positioning of output bits over 32 time positions per round instead of eight time positions per round in an averaged power signature for the DES computation, causing averaging of power signature events for predicted bits with those for a larger number of other bits.

Hash-Controlled Code-Padding Method

The code-padding method is similar in spirit to the average-neutral and permuted execution methods in that it randomly alters the observable processing, so that the power signature samples are no longer correlated with one another.

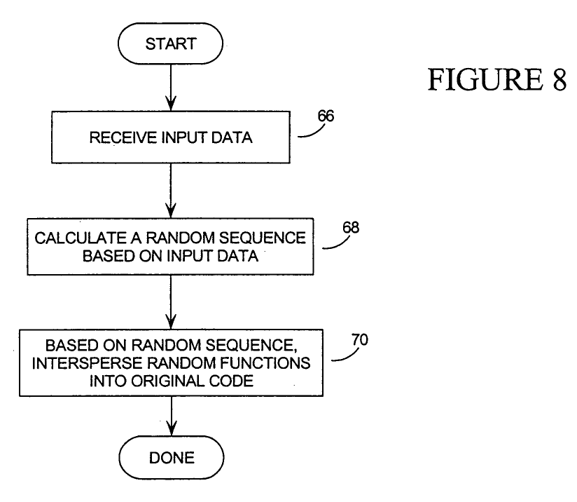

This technique is presented as a flow chart in FIG. 8. In response to ciphertext or plaintext data being input at step 66, the algorithm calculates a random value or sequence based on this input data at step 68. The random function used may be a suitable one known in the art. By using the input data as a seed for the random function, the random sequence will change with each set of data input.

Next, before processing the input data, the program algorithm is randomly altered by adding new executable code in accordance with the random value or sequence at step 70. The random functions may be selected, for example, from a table or via a boolean tree. As in the case of other embodiments of the invention, this technique makes it impossible to correlate the timing of the manipulations being performed by the sealed platform, so that output samples cannot be compared with one another.

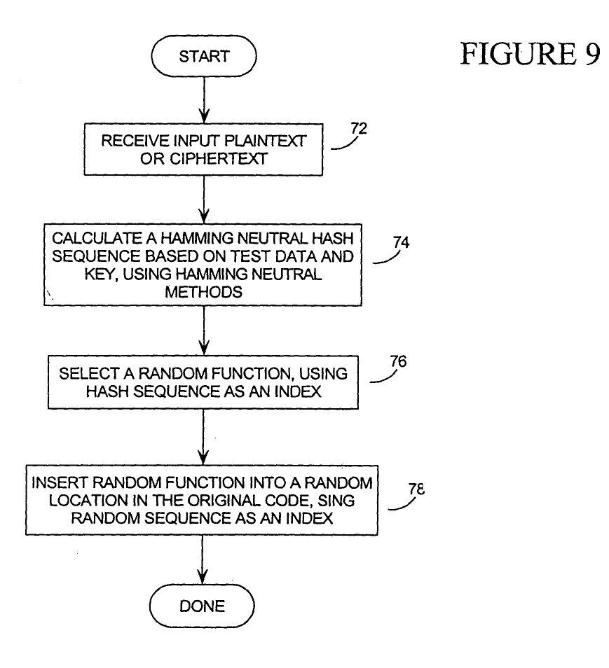

The specific application of this embodiment to a DES algorithm on a smart card is now described with respect to FIG. 9. As in the case of the other techniques, the process begins with ciphertext or plaintext being input at step 72. Next, the algorithm uses a Hamming-neutral hash computation to generate a sequence based on the input information at step 74. The sequence contains only Hamming-neutral data elements.

The hash sequence is used at steps 76 and 78 to generate random functions, and to insert those random functions into random locations in the original software code, respectively. The effect of interspersing these random computations with the normal computations is to cause timing of features observable by power analysis to shift in a pseudo-random fashion, helping to foil timing-based attacks such as those described in Paul C. Kocher, 1995, Timing attacks on implementations of Diffie-Hellman, RSA, DSS, and other systems, (this document is available at http://www.cryptography.com/timingattack/).

As noted above, upwards of a 1000 sets of test code are analysed and averaged together in a DPA attack. However, it is important that the samples are correlated in time with one another, so that they represent the power level at the same point in the software code. This code padding embodiment of the invention makes it impossible to match samples together that correspond to the same section of code.

One must be careful in the application of this aspect of the invention, as much added code could be easily separated out by a combination of SPA and DPA, leaving a raw trace. If it is necessary to avoid an aggressive attack, it is important to consider the following factors:

1. using Hamming-neutral hashes so that the attacker cannot determine the control values, which would let him strip out the added code;

2. the delays being controlled by a hash of all the input values, ensuring that every trace will have a different delay and that the attacker cannot manipulate the system into producing a desired hash value;

3. the added code being indistinguishable from real code, otherwise the attacker can easily remove it. The simplest way is to add more S-box lookups; and

4. avoiding the use of solutions such as delay loops which are likely to produce a distinctive power signature.

As mentioned above, it is also important to use Hamming-neutral computations in producing the hash output value sequence. If the computations were not Hamming-neutral, the contents of the sequence would be compromised, potentially increasing the predictability of timings, and making it easier for an attacker to obtain information from power feature timing.

Hamming-Neutral Data

As noted in the Background to the Invention above, basic data representation in a Hamming-neutral form is well known in the art. However, more advanced forms of Hamming-neutral representation are presented in the co-pending Patent Application Serial No. ______, titled: “Encoding Method and System Resistant to Power Analysis”, filed under the Patent Cooperation Treaty.

General Hamming-Neutral Execution Methods

Hamming-neutral execution refers to the execution of basic computations without exposing information to power analysis by either Hamming-weight leakage or transition count leakage. As well, Hamming-neutral execution should not leak information about layout of data tables.

The techniques for Hamming-neutral execution in the manner of the invention, do increase execution time and data storage space. However, in the context of sealed platforms, the overheads they impose are repaid by the protection they provide against power analysis attacks.

From the techniques described herein, it is possible to perform computations such as shifts, additions, boolean, bit-wise boolean, and other operations, in such a way that transition-count leakage and Hamming-weight leakage do not compromise information one wishes to protect.

Avoiding Transition Count Leakage

Mere use of Hamming-neutral data representations and Hamming-neutral addressing of data tables is not sufficient to avoid transition count leakage. To avoid transition count leakage of data, addresses, and certain computational operations, one must generally perform computations in accordance with the following general principal:

If two operations are not to be distinguishable by transition count, then they must have the same transition count. Moreover, the number of 1-bits which transition to 0-bits should be the same for the two operations, and the number of 0-bits which transition to 1-bits should both be the same for the two operations. This is feasible in general, either by use of Hamming-neutral table-lookups to implement operations, or by careful implementations using combinations of ordinary computational instructions, or by some combination of these two techniques, as will be evident to anyone skilled in the art.

As noted, the number of transitions that take place during the computation can be kept constant. In traditional devices, the number of transitions is a function of the current and/or previous state(s) of the device, including the parameters of the particular computation. Leakless devices can be designed for which the type and timing of state transitions during each part of a computation are independent of the parameters of the computation.

Performing Operations by Table Lookup

A number of techniques for performing Hamming-neutral calculations are presented in the co-pending Patent Application Serial No. ______, titled: “Method and Apparatus for Balanced Electronic Operations”, filed under the Patent Cooperation Treaty. The simplest technique is the use of look-up tables.

Whenever an operation takes one or more operands whose representations are short, fixed-length bit-strings which use a Hamming-neutral encoding, one can simply create a table with suitable addressing which contains the results for the operation, and index into it by composing a suitable form of Hamming-neutral address, that is, an address from a set of addresses which is a Hamming-neutral set. If the result is to be concealed, one should also use a Hamming-neutral encoding for the data in the table elements. If the operation produces a result which need not be concealed, then the data elements in the table can use an ordinary, non-Hamming-neutral representation.

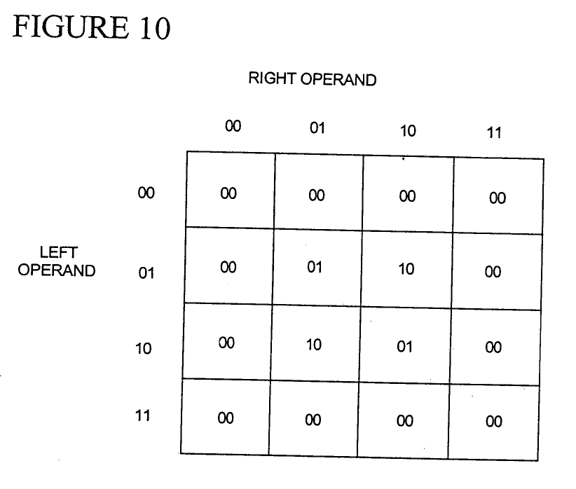

An exemplary XOR (exclusive OR) operation table for a single pair of bit-encoded Boolean values is shown in FIG. 10. This example presents a simple Hamming-neutral mapping of 0→01, 1→10; with a high output (10) only when one of the inputs is high.

Almost any kind of operation can be performed by a table lookup, or a sequence of table lookups, based on this technique. For example, since one can add, subtract, or multiply one digit at a time, using multiplication and addition tables, and since these operations are also sufficient for long division, one can do integer arithmetic in a Hamming-neutral way, so that (as long as one are careful to avoid transition count leakage as noted previously) one can perform integer arithmetic on data without leaking any information about that data to power analysis.

Bit-wise Boolean operations can also be performed using tables. For example, a table whose elements are stored as bytes, in sufficient for doing arbitrary binary masking operations on operands encoded in eight bits, but representing six bits.

Shifting can also be done using a table-driven approach. Since one can do Boolean operations as well, one can perform arbitrary computations using the techniques described herein, including floating point computations. These techniques may not be suited to high-speed computation or operation in minimal memory space, however, they are highly suited to execution resistant to SPA or DPA attacks.

In its ordinary form (that is, without use of Hamming-neutral methods) DES encryption or decryption involves only the following kinds of operations:

1. bitwise XOR (exclusive OR) operations;

2. selecting and permuting the bits in a string according to a stored table of integers, as in the initial and final permutations, the expansion permutation, and the compression permutation;

3. extraction of a substring within a bit-string; and

4. concatenation of bit-strings.

Bitwise XOR can be done by table lookup with a table as shown in FIG. 10, one pair of Boolean operands at a time, so that instead of a 48-bit wide XOR one performs 48 individual XOR operations, handling one bit-position at a time. Selecting and permuting bits, both for wide XOR operations and for other purposes, can also be done by creating appropriate lookup tables.

Therefore, the entire DES operation can be performed using the techniques discussed herein.

Combined Execution Methods

Any subset of the following can be combined with the method of the invention: techniques described in the co-pending patent application Ser. No. ______, titled: “Method and Apparatus for Balanced Electronic Operations”, or Hamming-neutral representations presented in the co-pending patent application Ser. No. ______, titled: “Encoding Method and System Resistant to Power Analysis”. Greater protection is obtained by using these methods at the same time.

Different subsets of the above methods may also be used for different parts of the same program to be protected, depending on the degree of protection with which one wishes to provide each different part.

In addition, the above methods may be combined, individually or severally, with the methods of producing tamper-resistant, secret-hiding software described in the co-pending data flow patent application, U.S. patent application Ser. No. 09/329,117, filed Jun. 9, 1999, titled: “Tamper Resistant Software Encoding”, the co-pending control flow patent application, U.S. patent application Ser. No. 09/377,312, filed Aug. 19, 1999, titled: “Tamper Resistant Software Control Flow Encoding”, and the co-pending Canada Patent Application, Serial No. 2,305,078, filed Apr. 12, 2000, titled: “Tamper Resistant Software—Mass Data Encoding” to provide a still greater range of protection for a program. Different subsets of the above methods may also be used for different parts of the same program to be protected, depending on the degree of protection with which one wishes to provide each different part.

These techniques may also be combined with other security techniques known in the art such as physical protection or noise introduction, though some of the advantages of the invention may be compromised.

Effect of Applying the Invention

The implementations according to the instant invention are protected against both SPA and DPA by one or more of the following:

1. removal of features or differences in power profiles, both individual and averaged, by use of computational methods which avoid many situations in which power features or differences would otherwise be expected; and

2. removal of differences between averaged power profiles, by use of computational methods which render such profiles statistically neutral, on average, where they would ordinarily be expected to show distinct differences.

With the comprehensive application of the invention, input and output data from S-box lookups, and the incoming operands and results of all xor operations and permutations, bit-selections, and the like, are all concealed. That is, anything which is specific to the DES key is concealed against power-analysis attacks.

The techniques provide protection against revealing any or all of: the data, the data addresses, and the code addresses employed during execution.

While particular embodiments of the present invention have been shown and described, it is clear that changes and modifications may be made to such embodiments without departing from the true scope and spirit of the invention.

It is understood that as attacking tools become more and more powerful, the degree to which the techniques of the invention must be applied to ensure an adequate level of security, will also rise. It is understood, therefore, that the utility of some of the simpler claimed techniques may correspondingly decrease over time. One skilled in the art would appreciate this and apply the invention accordingly.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

Because some aspects of the instant invention require precise control over instructions used in algorithms and data layouts in memory, the instant invention is most applicable to assembly- or machine-level implementations. It is less applicable to high-level language (HLL) implementation, because compilers for HLLs usually do not provide the programmer with sufficient control over instruction and memory usage to permit the instant invention to be used effectively.

However, it is possible to employ some or all of the techniques of the instant invention in code generation by a compiler for some HLL. Such a compiler could then be employed to generate PA-resistant machine-code or assembly-code from source-code written in the HLL.

There are many uses for software applications which embed and employ a secret encryption key without making either the cryptographic key or a substitute for the cryptographic key available to an attacker. The method of the invention can generally be applied to these applications.

The embodiments of the invention may be executed by a computer processor or similar device programmed in the manner of method steps, or may be executed by an electronic system which is provided with means for executing these steps. Similarly, an electronic memory medium may store code executable to perform such method steps. Suitable memory media would include serial access formats such as magnetic tape, or random access formats such as floppy disks, hard drives, computer diskettes, CD-Roms, bubble memory, EEPROM, Random Access Memory (RAM), Read Only Memory (ROM), optical media, or magneto-optical media or similar computer software storage media known in the art. Furthermore, electronic signals representing these method steps may also be transmitted via a communication network.

The invention could also be implemented in hardware, or a combination of software and hardware including software running on a general purpose processor, microcode, PLAs, ASICs, and any application where there is a need for leak-minimized cryptography that prevents external monitoring attacks.

It will be clear to one skilled in these arts that there are many practical embodiments of the DES implementation produced by the instant invention, whether in normal executable machine code, code for a virtual machine, or code for a special purpose interpreter. It would also be possible to directly embed the invention in a net-list for the production of a pure hardware implementation, that is, an ASIC.

Typically, the methods and apparatuses of the present invention might be embodied as program code running on a processor, for example, as instructions stored on in the memory of a smart card. Where greater security is desired, the code might additionally be signed by a trusted party, for example, by the smart card issuer. The invention might be embodied in a single-chip device containing both a nonvolatile memory for key storage and logic instructions, and a processor for executing such instructions.

It would also be clear to one skilled in the art that the invention need not be limited to the described scope of credit, debit, bank and smart cards. An electronic commerce system in a manner of the invention could for example, be applied to: point of sale terminals; vending machines; cryptographic smart cards of all kinds including contactless and proximity-based smart cards and cryptographic tokens; stored value cards and systems; electronic payment, credit and debit cards; secure cryptographic chips, microprocessors and software programs; pay telephones, prepaid telephone cards, cellular telephones, telephone scrambling and authentication systems; security systems including: identity verification systems, electronic badges and door entry systems; systems for decrypting television signals including broadcast, satellite and cable television; systems for decrypting enciphered music and other audio content (including music distributed over computer networks); and systems for protecting video signals. Such implementations would be clear to one skilled in the art, and do not take away from the invention.

We claim:

1. A method of processing a message using a cryptographic algorithm in a manner resistant to external detection of secret information, comprising the steps of:
receiving input data;
generating a random value; and
substantively altering the observable operation of said cryptographic algorithm while processing said input data, in accordance with said random value, frustrating the correlation of output power emissions with any meaningful internal processing.

2. The method as claimed in claim 1, wherein said random value comprises a sequence of random values.

3. A method of increasing the resistance to external detection of secret information, of a cryptographic key-based algorithm, comprising the steps of:
removing differences between averaged power profiles.

4. The method as claimed in claim 3, wherein said step of removing comprises:
removing differences between averaged power profiles by use of computational methods which render such profiles statistically neutral, on average, where they would otherwise be expected to show distinct differences.

5. The method as claimed in either of claims 1 or 2, wherein said step of altering comprises the step of randomly inverting the sense of contiguous sequences of arguments, resulting neutral averaging of the power signature.

6. The method as claimed in either of claims 1 or 2, wherein said step of altering comprises the step of randomly selecting between normal and bit-inverted execution paths, thereby balancing high and low Hamming weights and transitions.

7. The method as claimed in either of claims 1 or 2, wherein said step of altering comprises the steps of:
for a given argument:
creating a complementary bit-inverted argument; and
randomly selecting between said argument and said complementary bit-inverted argument during execution;
thereby balancing bit states and transitions to moderate or eliminate statistically average differentiation.

8. The method as claimed in claim 1, wherein said step of generating comprises the step of:
calculating a random sequence based on said input data.

9. The method as claimed in claim 8, wherein said step of altering comprises the step of:
responding to the valuation of said random sequence, by either:
performing normal cryptographic execution; or
performing inverted cryptographic execution;
thereby balancing high and low Hamming weights and transitions.

10. The method as claimed in either of claims 1 or 2, wherein said step of altering comprises the step of:
permuting the order of execution of software instructions, de-synchronising the relationship between software code execution and the timeline and causing averaging of power signature events for predicted bits, with those of other bits.

11. The method as claimed in claim 10, wherein said step of permuting comprises the step of permuting the order of S-box lookups within a given round of a DES-type algorithm.

12. The method as claimed in claim 11, further comprising the step of:
replacing 8×4-bit S-boxes with 32×1-bit S-boxes, prior to said step of permuting the order of S-box lookups, thereby resulting in finer grain.

13. The method as claimed in claim 12, wherein said step of generating comprises the step of:
calculating a random sequence based on said input data.

14. The method as claimed in claim 13, wherein said step of altering comprises the step of:
responding to the valuation of said random sequence, by re-ordering execution of operations.

15. The method as claimed in either of claims 1 or 2, wherein said step of altering comprises the step of time shifting the executable code.

16. The method as claimed in claim 15, wherein said step of time shifting comprises the steps of:
interspersing pseudo-randomly selected functions into said cryptographic algorithm;
thereby disorienting time based attacks which assume that the elapsed time between successive executions of said cryptographic algorithm will be consistent.

17. The method as claimed in claim 16, wherein said step of generating comprises the step of:
calculating a random sequence based on said input data.

18. The method as claimed in claim 17, wherein said step of altering comprises the step of:
responding to the valuation of said random sequence, by interspersing arguments determined by said random sequence, into said cryptographic algorithm.

19. The method as claimed in any one of claims 1-18, wherein said step of calculating comprises the step of:
calculating a random hash sequence based on said input data.

20. The method as claimed in claim 19, wherein said step of calculating comprises the step of:
calculating a random hash sequence based on said input data, using Hamming-neutral computational methods.

21. The method as claimed in claim 20, wherein said step of calculating comprises the step of:
calculating a random hash sequence of Hamming neutral values, based on said input data, using Hamming-neutral computational methods.

22. An apparatus for processing a message using a cryptographic algorithm in a manner resistant to external detection of secret information, comprising:
means for receiving input data;
means for generating a random value; and
means for substantively altering the observable operation of said cryptographic algorithm while processing said input data, in accordance with said random value, frustrating the correlation of output power emissions with any meaningful internal processing.

23. A computer readable memory medium for storing software code executable to perform the method steps of:
receiving input data;
generating a random value; and
substantively altering the observable operation of said cryptographic algorithm while processing said input data, in accordance with said random value, frustrating the correlation of output power emissions with any meaningful internal processing.

24. A carrier signal incorporating software code executable to perform the method steps of:
receiving input data;
generating a random value; and
substantively altering the observable operation of said cryptographic algorithm while processing said input data, in accordance with said random value, frustrating the correlation of output power emissions with any meaningful internal processing.
